(19) United States
(12) Patent Application Publication
(10) Pub. No.: US 2026/0050653 A1
(43) Pub. Date: Feb. 19, 2026

(54) PERFORMING IN-CONTEXT LEARNING USING SELECT POOL ENTRIES

(71) Applicant: International Business Machines Corporation, Armonk, NY (US)

(72) Inventors: Nitin Gupta, Saharanpur (IN); Manish Kesarwani, Bengaluru (IN); Sambit Ghosh, Madhyamgram (IN); Sameep Mehta, Bangalore (IN); Carlos Eberhardt, Wyoming, MN (US); Daniel Debrunner, Jacksonville, FL (US)

(21) Appl. No.: 18/803,146

(22) Filed: Aug. 13, 2024

(51) Int. Cl. G06F 18/22; G06N 3/0475; G06N 3/08

(52) U.S. Cl. CPC G06F 18/22; G06N 3/0475; G06N 3/08

(57) ABSTRACT

A method, according to one approach, includes: receiving a test sample having schema information and natural language information. The schema information is compared to a pool of entries that correspond to a given query language. One or more entries in the pool that match the schema information of the test sample are identified. One or more entries in the pool that match the natural language information of the test sample are also identified. The method also includes merging selected ones of the entries that match the schema information and selected ones of the entries that match the natural language information. Furthermore, a large language model performs in-context learning using the merged entries and the test sample.

### BACKGROUND

The present invention relates to model tuning, and more specifically, this invention relates to performing in-context learning.

Increased data production has amplified the overhead associated with performing data processing. While Artificial Intelligence (AI) has been developed in an attempt to combat this rise in processing overhead, advancements in AI have caused the complexity of machine learning models to increase as well. Increasingly complex machine learning models translate to more intense workloads and increased strain associated with applying the models to received data. The operation of conventional implementations has thereby been negatively impacted.

These impacts also stem from the fact that query languages implemented in application programming interfaces (APIs) used to fulfil queries with existing data have become increasingly complex. According to an example, which is in no way intended to be limiting, GraphQL is a query language that enables an end user to retrieve relevant data from diverse data sources, e.g., including API's, relational database management system (RDBMS), and others. However, a major challenge in designing GraphQL queries is the complexity in understanding the schema, and as well as in generating query logic.

While attempts have been made to overcome this issue, the attempts have provided little to no context as to how various complex aspects of the result should be generated. Accordingly, a need exists for models that are capable of performing in-context learning, even in situations involving increasingly complex input conditions.

### SUMMARY

A method, according to one approach, includes: receiving a test sample having schema information and natural language information. The schema information is compared to a pool of entries that correspond to a given query language. One or more entries in the pool that match the schema information of the test sample are identified. One or more entries in the pool that match the natural language information of the test sample are also identified. The method also includes merging selected ones of the entries that match the schema information and selected ones of the entries that match the natural language information. Furthermore, a large language model (LLM) performs in-context learning using the merged entries and the test sample.

A computer program product, according to another approach, includes: one or more computer-readable storage media. The computer program product also includes program instructions that are stored on the one or more storage media to perform the foregoing method.

A computer system according to yet another approach, includes: a processor set, and one or more computer-readable storage media. The computer system also includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a representational diagram of a system, in accordance with one approach.

FIG. 3 is a flowchart of a method, in accordance with one approach.

FIG. 4A is a representational progression of converting a query schema, in accordance with one in-use example.

FIG. 4B is a representational progression of converting a pool entry, in accordance with one in-use example.

FIG. 4C is a representational view of two graphs compared to determine a common sub-isomorphic graph, in accordance with one in-use example.

FIG. 4D is a representational progression of converting category objects extracted from a given query schema, in accordance with one in-use example.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for dynamically evaluating the schema structure, schema context, as well as the natural language semantics of a sample. This allows for existing entries associated with a particular query language, e.g., such as GraphQL, to be identified from a pool as relevant to the particular sample. These identified entries may thereby be considered to be sufficiently “similar” to the received query, that they are used to perform in-context learning (e.g., training) for AI based models, e.g., such as large language models (LLMs). Approaches herein are thereby able to utilize selected entries to fine tune one or more models such that they are configured to generate responses to a received sample more efficiently and with more accuracy than conventionally achievable, e.g., as will be described in further detail below. It should also be noted that while approaches herein are described in the context of implementations that use GraphQL query language, this is in no way intended to be limiting. Any of the approaches herein may be applied in implementations that utilize any other desired type of schema-based query language, e.g., as would be appreciated by one skilled in the art after reading the present description.

In one general approach, a method includes: receiving a test sample having schema information and natural language information. The schema information is compared to a pool of entries that correspond to a given query language. One or more entries in the pool that match the schema information of the test sample are identified. One or more entries in the pool that match the natural language information of the test sample are also identified. The method also includes merging selected ones of the entries that match the schema information and selected ones of the entries that match the natural language information. Furthermore, a large language model (LLM) performs in-context learning using the merged entries and the test sample.

In another general approach, a computer program product includes: one or more computer-readable storage media. The computer program product also includes program instructions that are stored on the one or more storage media to perform the foregoing method.

In yet another general approach, a computer system includes: a processor set, and one or more computer-readable storage media. The computer system also includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved in-context learning code at block 150 for dynamically evaluating the schema structure, schema context, as well as the natural language semantics of a sample. This allows for existing entries associated with a particular query language, e.g., such as GraphQL, to be identified from a pool as relevant to the particular sample. These identified entries may thereby be considered to be sufficiently “similar” to the received query, that they are used to perform in-context learning for AI based models (e.g., such as LLMs). Approaches herein are thereby able to utilize selected entries to fine tune one or more models such that they are configured to generate responses to a received sample more efficiently and with more accuracy than conventionally achievable, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

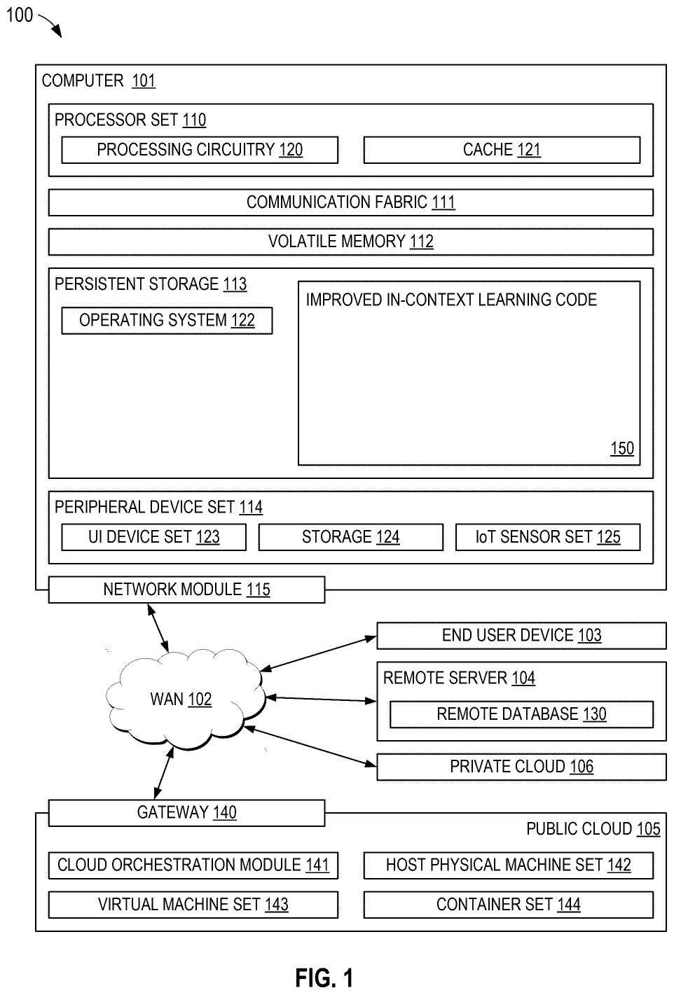

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, increased data production has amplified the overhead associated with performing data processing. While AI has been developed in an attempt to combat this rise in processing overhead, advancements in AI have caused the complexity of machine learning models to increase as well. Increasingly complex machine learning models translate to more intense workloads and increased strain associated with applying the models to received data. The operation of conventional implementations has thereby been negatively impacted.

These negative impacts also stem from the fact that query languages implemented in APIs used to fulfil queries with existing data have become increasingly complex. According to an example, which is in no way intended to be limiting, GraphQL is a query language that enables an end user to retrieve relevant data from diverse data sources, e.g., including API's, RDBMS, and others. However, a major challenge in designing GraphQL queries is the complexity in understanding the schema, and as well as in generating query logic.

While attempts have been made to overcome this issue by evaluating semantics related to natural language associated with GraphQL, this provides little to no context as to how various complex aspects of the result should be generated. Accordingly, a need exists for models (e.g., LLMs) that are capable of performing in-context learning, even in situations involving increasingly complex input conditions. The specific entries that are used to perform in-context learning play a crucial role in output generation. Again, GraphQL and other query languages are becoming increasingly complex. Accordingly, the language and semantic similarities associated with a query are not sufficient to adequately generate responses.

In sharp contrast to the foregoing shortcomings experienced by conventional systems, approaches herein are desirably able to select entries (e.g., source datasets) from a pool that are identified as being at least somewhat relevant to a received query. These entries are selected in response to dynamically evaluating the schema structure, schema context, as well as the natural language semantics of a sample. These identified entries may thereby be considered to be sufficiently “similar” to the received query, that they are used to perform in-context learning for AI based models (e.g., such as LLMs). Approaches herein are thereby able to utilize selected samples to fine tune one or more models such that they are configured to generate responses to a received sample more efficiently and with more accuracy than conventionally achievable, e.g., as will be described in further detail below.

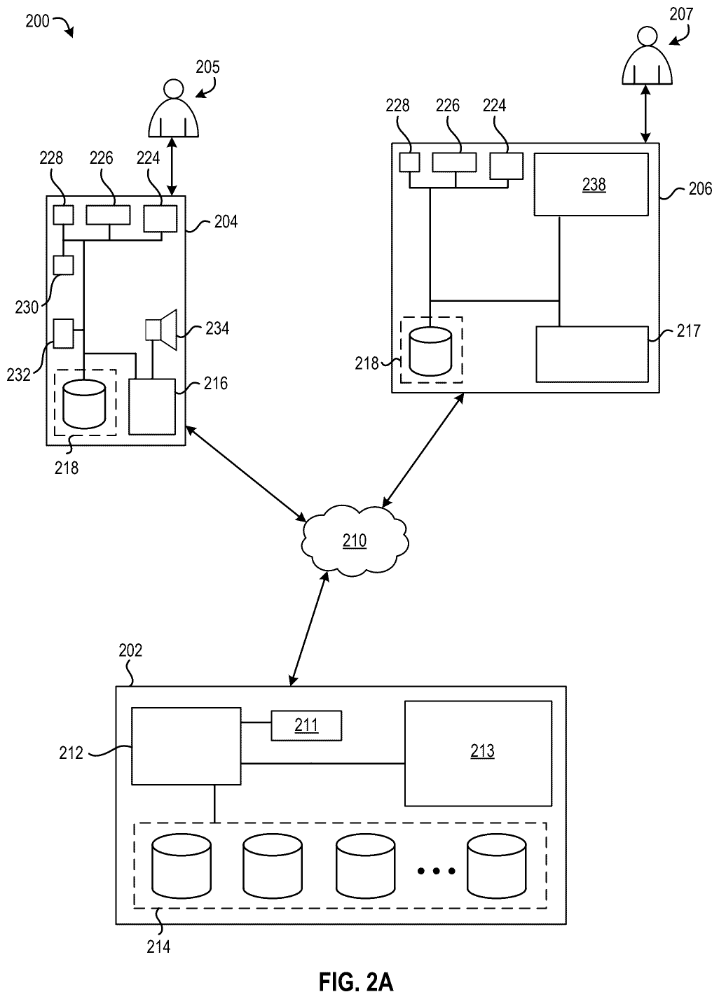

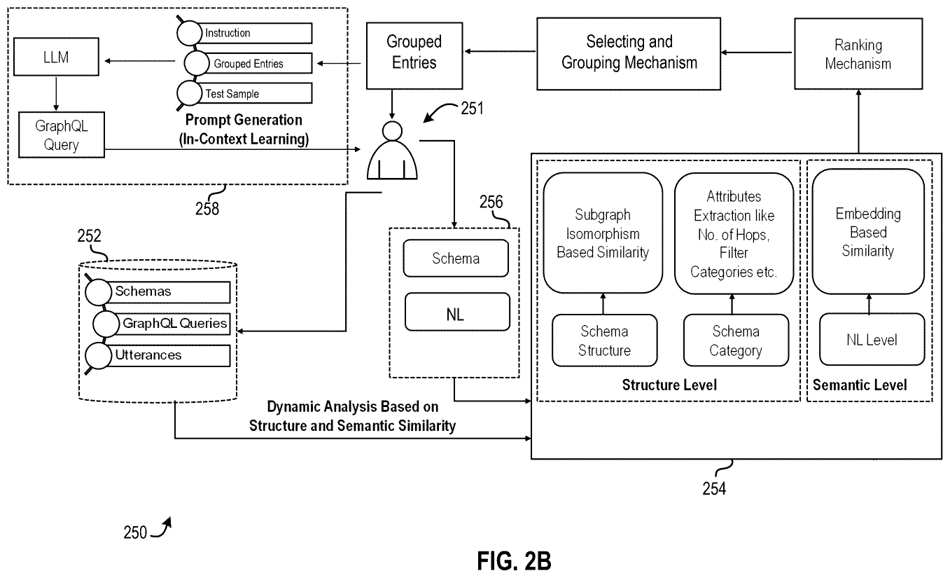

Looking now to FIG. 2A, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the system 200 includes a central server 202 that is connected to a user device 204, and edge node 206 accessible to the user 205 and administrator 207, respectively. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations. According to some approaches, the central server 202 is a remote cloud server that is connected to (e.g., may be accessed by) user device 204 and/or edge node 206.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

The terms “user” and “administrator” are in no way intended to be limiting either. For instance, while users and administrators may be described as being individuals in various implementations herein, a user and/or an administrator may be an application, an organization, a preset process, etc. The use of “data,” “datasets,” and “information” herein are in no way intended to be limiting either, and may include any desired type of details, e.g., depending on the type of operating system implemented on the user device 204, edge node 206, and/or central server 202. In some approaches, datasets of textual entries (e.g., strings of alphanumeric characters) that are generated at the edge node 206 may be kept at the edge node 206 to ensure data security and retention. For example, datasets having sensitive information (e.g., personal data, financial data, intellectual property, etc.) may intentionally be retained at an edge server where the datasets were formed, e.g., to ensure data security and privacy. However, other information deemed as not being sensitive may be sent to the central server 202 from user device 204 and/or edge node 206 for processing using one or more machine learning models.

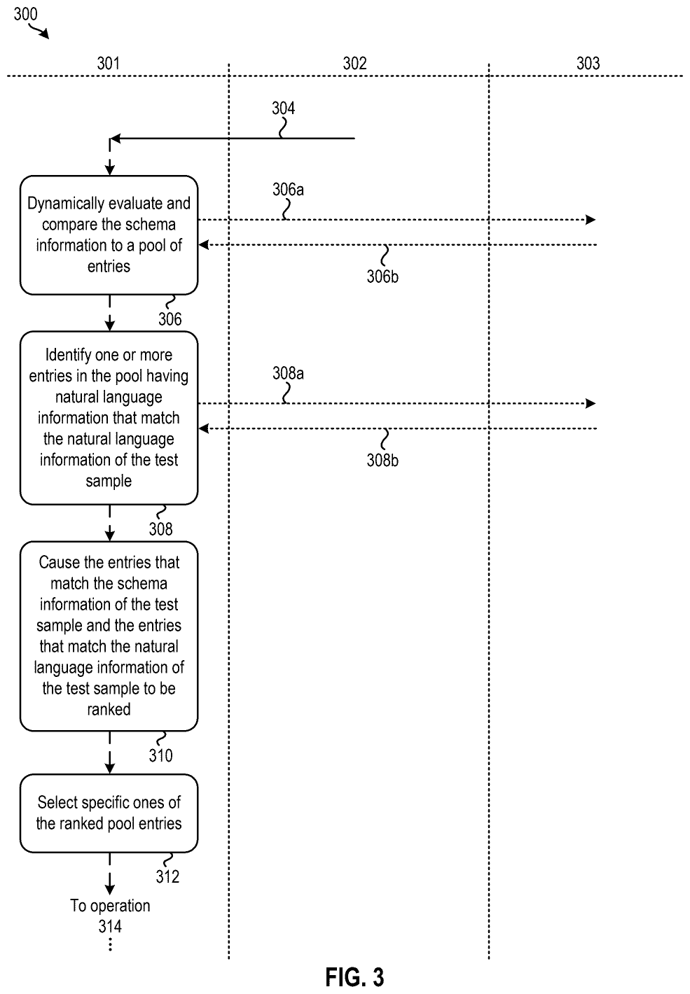

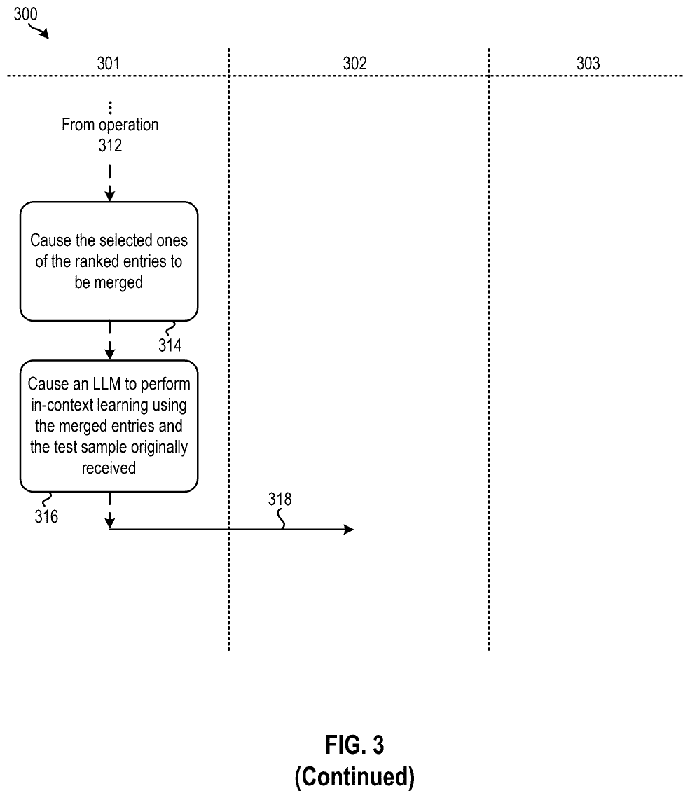

With continued reference to FIG. 2A, the central server 202 includes a large (e.g., robust) processor 212 coupled to a cache 211, an AI module 213, and a data storage array 214 having a relatively high storage capacity. The AI module 213 may include any desired number and/or type of AI-based models, e.g., such as machine learning models (e.g., LLMs), deep learning models, neural networks, etc. In preferred approaches, the AI module 213 and/or processor 212 is able to implement aspects of in-context learning for AI based models (e.g., such as LLMs). Moreover, the entries (e.g., source datasets) that are selected and used to perform the in-context learning are selected in response to dynamically evaluating the schema structure, schema context, as well as the natural language semantics of a sample. These identified entries may thereby be considered to be sufficiently “similar” to the received query, that they are used to perform in-context learning for AI based models (e.g., such as LLMs). Approaches herein are thereby able to utilize selected samples to fine tune one or more AI based models such that they are configured to generate responses to a received sample more efficiently and with more accuracy than conventionally achievable, as will be described in further detail below (e.g., see method 300 of FIG. 3).

With continued reference to FIG. 2A, user device 204 includes a processor 216 which is coupled to memory 218. The processor 216 receives inputs from and interfaces with user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

In some approaches, queries are received from 205 for evaluation and generating a response. In other approaches, data (e.g., non-sensitive data) may be received from user 205 for storage and/or evaluation using AI module 213 at central server 202. The data may be received as a result of the user 205 using one or more applications, software programs, temporary communication connections, etc. running on the user device 204. For example, the user 205 may upload data for storage at the data storage array 214 and evaluation using processor 212 and/or AI module 213 of central server 202. As a result, the data is evaluated and processed.

Looking now to the edge node 206, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an AI module 238.

As described above with respect to AI module 213, the AI module 238 may include any desired number and/or type of AI-based models. It follows that AI module 238 may implement similar, the same, or different characteristics as AI module 213 in central server 202. In some approaches, AI module 238 is configured to perform in-context learning for AI based models (e.g., such as LLMs). Moreover, the entries (e.g., source datasets) that are selected and used to perform the in-context learning may be selected in response to the AI module 238 and/or controller 217 dynamically evaluating the schema structure, schema context, as well as the natural language semantics of a sample. These identified entries may thereby be considered to be sufficiently “similar” to the received query, that they are used to perform in-context learning for AI based models (e.g., such as LLMs). Approaches herein are thereby able to utilize selected samples to fine tune one or more AI based models such that they are configured to generate responses to a received sample more efficiently and with more accuracy than conventionally achievable, as will be described in further detail below (e.g., see method 300 of FIG. 3).

Referring momentarily to FIG. 2B, a representational diagram of a system 250 selecting specific entries in a pool and using those selected entries to perform in-context learning (e.g., training) on one or more AI based models is illustrated in accordance with one approach which is in no way intended to be limiting. As shown in the system 250, a pool 252 (e.g., database) of entries may be accessible to an AI module 254. AI module 254 may thereby compare the entries in the pool 252 to a newly received test sample 256.

As shown, the test sample 256 includes Schema information and Natural Language (NL) information therein. Thus, in response to receiving the test sample 256, the AI module 254 separates the Schema Structure information from the Schema Category information received therein. The Schema Structure information may be used to compare various details about the structure of the received test sample 256, to the structures of the entries in pool 252. According to one example, which is in no way intended to be limiting, the Schema Structure information is used to perform a Subgraph Isomorphism Based Similarity operation with the entries in the pool 252. As a result, one or more of the entries in the pool 252 determined as having a schema structure that is sufficiently similar to that of the received test sample 256 may be identified and output as “matches”.

With respect to the present description, an entry in the pool 252 that is “sufficiently similar” to details of a received test sample 256 may be determined based on one or more ranges and/or thresholds that may be predetermined by users, based on past performance, etc. Moreover, this may be determined by actively converting schema information into a graphical representation, and identifying a maximum size query schema of the representation which is isomorphic to one or more subgraphs that correspond to the entries in the pool 252, e.g., as will be described in further detail below. It should also be noted that the pool 252 may be formed over time as queries are processed and the results are evaluated. In other approaches, one or more entries in the pool 252 may be imported from training datasets, remote systems and/or applications, directly from a user issuing one or more prompts, etc.

Moreover, the Schema Category information may be used to compare various details about the categories that may be included in the received test sample 256. According to one example, which is in no way intended to be limiting, the Schema Category information is used to perform Attributes Based Extraction from the received test sample. For example, Attributes Based Extraction may extract a number of hops, a number of filters, a number of categories, etc., from the received test sample 256. Moreover, these extracted attributes may be compared against known attributes associated with the respective entries in the pool 252. As a result, one or more of the entries in the pool 252 determined as having one or more schema categories that are sufficiently similar to the schema categories extracted from the received test sample 256 may be identified and output as “matches”. As noted above, an entry in the pool 252 that is “sufficiently similar” to details of a received test sample 256 may be determined based on one or more ranges and/or thresholds that may be predetermined by users, based on past performance, etc.

With continued reference to FIG. 2B, the AI module 254 further evaluates the received test sample 256 at a Semantic Level. For instance, the NL information may be extracted from the received test sample 256 and used to perform NL Level comparisons with entries in the pool 252. According to an example, Embedding Based Similarity may be determined by evaluating the NL information from the test sample 256 and comparing it with NL information associated with the respective entries in pool 252.

It follows that AI module 254 ultimately identifies several entries in the pool 252 that have schema structure, schema categories, and/or semantic information which is sufficiently similar to that of a received test sample 256. These identified entries from pool 252 and the received test sample 256 are thereby passed to a Ranking Mechanism. In some approaches, one or more instructions configured to cause the Ranking Mechanism to rank at least the identified entries sent from the pool 252 may be sent. It follows that Ranking Mechanism is preferably able to rank the various entries selected from pool 252 according to any desired standard. In some approaches, the Ranking Mechanism organizes the identified entries based on a relative similarity to the received test sample 256. The identified entries may be ranked together as a single group in some approaches, thereby causing the entries to be arranged based on similarities between different characteristics thereof. In other words, a single ranking that incorporates entries having similar schema structures, similar schema categories, and similar NL information may be combined. In other approaches, the identified entries may be separated into different groups, and each of the groups may be ranked based on the relative similarity of the entries therein. In other words, one ranking incorporates entries having similar schema structures, another ranking incorporates entries having similar schema categories, and still another ranking incorporates entries having similar NL information.

The ranked entries are thereby passed from the Ranking Mechanism to the Grouping and Selecting Mechanism. There, this Grouping and Selecting Mechanism evaluates the ranked entries provided by the Ranking Mechanism, and selects specific ones of the entries. The entries that are selected are at least somehow related to the received test sample 256. Depending on the approach, this may be based at least in part on the relative similarity between the ranked entries. In some approaches, a percentage range may be predetermined to quantify ranked entries that are sufficiently similar to the received test sample 256. In other approaches, a threshold may be used to separate ranked entries that are not sufficiently similar to the received test sample, from ranked entries that are sufficiently similar to the received test sample.

The selected entries are also preferably grouped together before being sent to an end application 258 and/or the user 251 that issued the received test sample 256. The end application 258 may thereby combine the grouped entries with the initial Test Sample 256, and one or more supplemental instructions. Accordingly, the grouped entries, the Test Sample, and the supplemental instructions are used to perform in-context learning on LLM and/or other AI based models. As noted above, the entries that are used to perform the in-context learning are selected in response to dynamically evaluating the schema structure, schema context, as well as the natural language semantics of a test sample. Approaches herein are thereby able to utilize selected samples to fine tune one or more AI based models such that they are configured to generate responses to a received sample more efficiently and with more accuracy than conventionally achievable. LLM thereby produces a GraphQL Query that is configured to generate prompts as a result of the in-context learning, as will be described in further detail below (e.g., see method 300 of FIG. 3).

It should be noted that the specific configuration illustrated in FIG. 2B is in no way intended to be limiting and the various components therein may be implemented in different configurations. For example, in some approaches, the various components in system 250 may each be located at a cloud location offering a centralized service to user 251. In other approaches, the end application may be running at an edge node, while the pool 252, AI module 254, Rank Mechanism, and Selecting and Grouping Mechanism may be operating at a cloud location, the cloud location and the edge node being connected over a network (not shown). In still other approaches, the end application may be running on a user device, while the pool 252 is located at a cloud location; and the AI module 254, Rank Mechanism, and Selecting and Grouping Mechanism are included at an edge node.

Again, languages implemented in APIs used to fulfil queries with existing data have become increasingly complex. According to an example, which is in no way intended to be limiting, GraphQL is a query language that enables an end user to retrieve relevant data from diverse data sources, e.g., including API's, RDBMS, and others. However, a major challenge in designing GraphQL queries is the complexity in understanding the schema, and as well as in generating query logic.

While attempts have been made to overcome this issue by evaluating syntax related information included in GraphQL queries, this provides little to no context as to how various complex aspects of the result should be generated. According to an example which emphasizes this point, RDBMS has a relational structure over associated data, thereby allowing for Structured Query Language (SQL) to query the data without any additional restrictions based on the input schema. In contrast, GraphQL generally involves a cyclic graph structure over the output and the query operations are also restricted and vary based on the input schema. For example, it is important to understand the structure and restrictions of a GraphQL schema that provides only two access points for data, while RDBMS is less schema dependent.

Looking now to FIG. 3, a method 300 for dynamically evaluating the schema structure, schema context, as well as the natural language semantics of a sample, thereby allowing for existing entries associated with a particular query language, e.g., such as GraphQL, to be identified from a pool as relevant to the particular sample. These entries are selected in response to dynamically evaluating the schema structure, schema context, as well as the natural language semantics of a sample. These identified entries may thereby be considered to be sufficiently “similar” to the received query, that they are used to perform in-context learning for AI based models (e.g., such as LLMs). This in-context learning allows for detailed and directed re-training of one or more existing AI based models to be achieved. One or more of the operations in method 300 are thereby able to utilize selected entries to fine tune one or more models such that they are configured to generate responses to a received sample more efficiently and with more accuracy than conventionally achievable.

For example, one or more AI models may be re-trained with the specific entries identified as being sufficiently “similar” to the received query, thereby learning how to generate responses to the received query and similar queries more efficiently and with more accuracy than achievable prior to the re-training occurring. In other words, the contextual insight gained by the one or more AI models during the re-training using the selected entries allows the AI models to generate responses more quickly and with less compute overhead. Re-training may include reward feedback that may, in some approaches, be implemented using a subject matter expert (SME) that generally understands schema structure, schema context, as well as the natural language semantics of a sample. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this re-training, a decision that the model is sufficiently re-trained and ready to deploy for performing at least some of the techniques and/or operations of method 300 may be performed. In some further approaches, the AI model may be a neuromyotonic AI model that may improve performance of computer devices in an infrastructure associated with schema structure, schema context, and natural language semantics of samples, because the neuromyotonic AI model may not need an SME and/or iteratively applied re-training with reward feedback in order to accurately perform operations described herein. Instead, the neuromyotonic AI model may be configured to, itself make determinations described in operations herein. Weight values may, in some approaches, be used by the AI reasoning model to collect and analyze information and/or feedback potentially received from an interaction. Such an AI model ensures that specific types of queries are predicted, e.g., based at least in part on the directed re-training. The AI model(s) may also ensure that runnable exploit scripts that incorporate the queries are automatically generated and tested, where the scale of such analysis and determinations would not otherwise be feasible for a human to perform. This is because humans are not able to efficiently do so, and would otherwise incorporate processing delays and errors in the process of performing the approaches included herein.

One or more of the operations in method 300 may also be used to apply models that have undergone in-context training to new queries and/or datasets at an edge location during a target training step which creates a final model that has been trained in view of the context gleaned from the chosen entries during the in-context training step. Accordingly, the operations of method 300 may be performed continually in the background of an operating system without requesting input from a user (e.g., human). Moreover, while certain information (e.g., warnings, reports, read requests, etc.) may be generated and/or issued to a user, it is again noted that the various operations of method 300 can be repeated in an iterative fashion for new test samples (e.g., user queries) that are received. Thus, method 300 may be performed in accordance with the present invention in any of the environments depicted in FIGS. 1-2B, among others, in various approaches. Of course, more or less operations than those specifically described in FIG. 3 may be included in method 300, as would be understood by one of skill in the art upon reading the present descriptions.

Each of the steps of the method 300 may be performed by any suitable component of the operating environment. For example, each of the nodes 301, 302, 303 shown in the flowchart of method 300 may correspond to one or more processors positioned at a different location in a distributed data production and storage system. Moreover, each of the one or more processors are preferably configured to communicate with each other.

In various implementations, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As mentioned above, FIG. 3 includes nodes 301, 302, 303, each of which represent one or more processors, controllers, computers, etc., positioned at a different location in a distributed data storage system. For instance, node 301 may include one or more processors located at a central data storage location (e.g., cloud server) of a distributed compute system (e.g., see central server 202 of FIG. 2A above). Node 302 may include one or more processors located at a user location that may be running an application (e.g., see processor 216 of FIG. 2A above). Furthermore, node 303 may include one or more processors located at an edge node of the distributed system (e.g., see controller 217 of FIG. 2A above). Accordingly, commands, data, requests, etc. may be sent between the nodes 301, 302, 303 depending on the approach.

It should also be noted that the various processes included in method 300 are in no way intended to be limiting, e.g., as would be appreciated by one skilled in the art after reading the present description. For instance, data sent from node 302 to node 301 may be prefaced by a request sent from node 301 to node 302 in some approaches. Additionally, the number of nodes included in FIG. 3 is in no way intended to be limiting. For instance, additional edge nodes may be included in some approaches. Accordingly, any desired number of edge nodes may be connected to the central server, e.g., as would be appreciated by one skilled in the art after reading the present description.

As shown in the flowchart, node 302 initiates operation 304, which includes sending a test sample to node 301. It should be noted that while the test sample is shown as being received from node 302 specifically in FIG. 3, this is in no way intended to be limiting. The test sample received at node 301 typically includes information that outlines different aspects of the sample being submitted. According to preferred approaches, the test sample received at node 301 includes schema information and natural language information.

As noted above, schema information may include details that are at least somewhat related to a schema structure of the received test sample, as well as schema category details that outline the one or more categories that may be included in the receive test sample. The schema information may further be compared against schema information associated with the various entries in a pool (e.g., repository) to identify sufficiently similar entries, e.g., as will be described in further detail below. Similarly, the natural language information (e.g., semantic level details in recordings of utterances, textual character strings extracted from documents, conversions of audio recordings into transcripts, etc.) may be used to evaluate the received test sample and compare it against the natural language information in the various pool entries, e.g., again as will be described in further detail below.

In response to receiving the test sample, method 300 advances to operation 306. There, operation 306 includes dynamically evaluating and comparing the schema information to a pool of entries. In other words, operation 306 includes evaluating and comparing the schema information to the pool entries in real-time, e.g., as the information is received. As noted above, the entries in the pool typically correspond to a given query language for interacting with APIs, e.g., such as GraphQL. However, it should be noted that a pool may include entries that correspond to more than one different query language. Moreover, some approaches herein refer to pools of entries that may be compared against received test samples as “few shot pools” which is in no way intended to be limiting, and may be referred to differently as desired.

As mentioned above, the process of dynamically evaluating and comparing the schema information to a pool of entries involves evaluating schema based information as well as semantic based information included in the test sample. For instance, a structure of the schema information may be compared to structures of the entries in the pool. This will help identify samples that are similar to a test sample at schema structure level. In some approaches, this step involves converting schema structure information into a graphical representation. Moreover, this may be used to identify a maximum size query schema of the representation which is isomorphic to one or more subgraphs that correspond to the entries in the pool. Similarity metrics may also be designed on top of this.

One or more categories associated with the schema information received in the test sample may also be compared against categories that are associated with the respective entries in the pool. It follows that each of the respective entries in the pool preferably include schema information, natural language information, and corresponding query information. As noted above, the schema information preferably further includes structure information as well as category information associated with the respective pool entry. However, some entries may include additional, alternative, or less information, e.g., depending on the desired approach.

With continued reference to FIG. 3, operation 306 is thereby illustrated as communicating with the pool of entries at node 303. See steps 306a and 306b. For example, schema and/or semantic based information extracted from a received test sample may be sent to the pool at node 303 in step 306a such that it may be compared against information associated with the entries therein. Moreover, any findings may be returned from the pool at node 303 to node 301 in step 306b.

From operation 306, method 300 advances to operation 308. There, operation 308 includes identifying one or more entries in the pool having natural language information that match the natural language information of the test sample. In other words, operation 308 includes selecting ones of the entries in the pool at node 303 identified as being sufficiently similar to at least a portion of the semantics associated with the received test sample. Operation 308 is thereby illustrated as communicating with the pool of entries at node 303. See steps 308a and 308b. For example, semantic based information extracted from a received test sample may be sent to the pool at node 303 in step 308a such that it may be compared against semantic information associated with the entries therein. Moreover, any findings may be returned from the pool at node 303 to node 301 in step 308b.

It follows that in operations 306 and 308, identifying entries in the pool that are sufficiently similar to details included in a received test sample may involve calculating similarity scores. For example, identifying one or more entries in the pool having schema information that matches at least a portion of the schema information in a test sample involves calculating a similarity score between the schema information of the test sample and the schema information of each of the respective entries in the pool. Similarly, identifying one or more entries in the pool having natural language information that match the natural language information of the test sample includes calculating a similarity score between the natural language information of the test sample and the natural language information of each of the respective entries in the pool.

Accordingly, from operation 308, method 300 advances to operation 310. There, operation 310 includes causing the entries returned from the pool at node 303 to be ranked. In other words, operation 310 includes causing the entries that match the schema information of the test sample and the entries that match the natural language information of the test sample to be ranked. In some approaches, operation 310 includes sending one or more instructions to a ranking mechanism that is configured to arrange the various entries identified from the pool according to one or more standards. For example, the ranking mechanism may be configured to generate and/or evaluate similarity scores that quantify how closely the schema structure, schema categories, and/or natural language information of certain pool entries match corresponding information in the received test sample. In other approaches, the ranking mechanism may reference user preferences, industry standards, past performance, identified (e.g., learned) patterns, real-time performance, etc. in order to determine how various pool entries should be arranged.

In some approaches, the ranking mechanism may merge each of the similarity scores and sort them based on their relative similarity. For instance, some implementations may arrange the potential pool entries from most similar to least similar. Other implementations may arrange the pool entries from least similar to most similar. In other approaches, the ranking mechanism may apply weighted values to at least some of the potential pool entries. In other words, the ranking mechanism may be configured to rank (e.g., sort or order) the entries that match the schema information and/or the entries that match the natural language information based at least in part on a weighted combination (e.g., a weight applied to at least some) of the similarity scores. These weighted values may be applied to certain similarity scores based on user input, usage patterns, reliability of the pool entries themselves, etc. Moreover, the weighted scores may be arranged as desired.

Method 300 proceeds from operation 310 to operation 312. There, operation 312 includes selecting specific ones of the ranked pool entries. In other words, operation 312 includes selecting ones of the ranked entries that are sufficiently similar to the schema information as well as selecting ones of the ranked entries that are sufficiently similar to the natural language information. The ranked pool entries that are actually selected in operation 312 may vary depending on the approach. For instance, in some approaches the “N” potential pool entries with a highest similarity score to the respective characteristics of the received test sample may be selected. Thus, depending on how similar each pool entry is to the respective schema information and/or natural language information, different configurations of pool entries may be selected. However, in other approaches, the pool entries may be selected in a circular fashion.

In other words, the ranking of pool entries based on their respective similarity scores with schema structure may be referenced to select a first pool entry, while the ranking of pool entries based on their respective similarity scores with schema categories may be referenced to select a second pool entry, and the ranking of pool entries based on their respective similarity scores with natural language may be referenced to select a third pool entry. Moreover, this progression may be repeated any desired number of times to develop a collection of pool entries that are sufficiently similar to the test sample.

It follows that once samples are fetched, they can be re-grouped to provide additional context. According to an example, if selected pool entry 1 and pool entry 2 have the same schema based information, those entries be combined to produce a single schema and multiple queries, e.g., as would be appreciated by one skilled in the art after reading the present description.

Proceeding now from operation 312 to operation 314, there operation 314 includes causing the selected ones of the ranked entries to be merged. In other words, operation 314 includes merging (e.g., grouping) the specific pool entries that are selected in operation 312. Moreover, operation 316 includes causing an LLM (and/or other desired type of AI based model) to perform in-context learning using the merged entries and the test sample originally received. The in-context learning may further implement one or more instructions that may cause the AI based model to actually perform the training process involved with the in-context learning. In some approaches, the LLM is configured such that it performs the in-context learning at an end application (e.g., see end application 258 of FIG. 2B). The end application may be hosted at an edge node, offered at a central server, running on a user device, etc. Moreover, the pool of entries may be stored at a cloud location in some approaches.

In response to performing the in-context learning at operation 316, method 300 advances to operation 318. There, operation 318 includes using the trained LLM to generate a query based on the received test sample. In other words, the trained LLM is able to generate a new (e.g., unique) GraphQL query response that is relevant to the initially received test sample. Moreover, operation 318 includes returning the query response generated in operation 316 to node 302. Accordingly, operation 318 includes using the new GraphQL query generated by the trained LLM to solve the test sample.

It follows that approaches herein are desirably able to dynamically evaluate the schema structure, schema context, as well as the natural language semantics of a sample, thereby allowing for existing entries associated with a particular query language, e.g., such as GraphQL, to be identified from a pool as relevant to the particular sample. These identified entries may thereby be considered to be sufficiently “similar” to the received query, that they are used to perform in-context learning for AI based models (e.g., such as LLMs). One or more of the operations in method 300 are thereby able to utilize selected entries to fine tune one or more models such that they are configured to generate responses to a received sample more efficiently and with more accuracy than conventionally achievable.

In addition to fielding the test sample received from node 302, approaches herein are also able to respond to newly received test samples. It follows that any one or more of the operations in method 300 may be repeated for subsequently received test samples over time. Approaches herein may also be implemented in hosted and unified service which could be implemented by any desirable application, product, host, cloud location, etc. that involves generating queries for specific languages (e.g., GraphQL) on the fly. Accordingly, the approaches herein may allow for powerful and effective generation capabilities at edge locations that may have limited compute power, e.g., as would be appreciated by one skilled in the art after reading the present description.

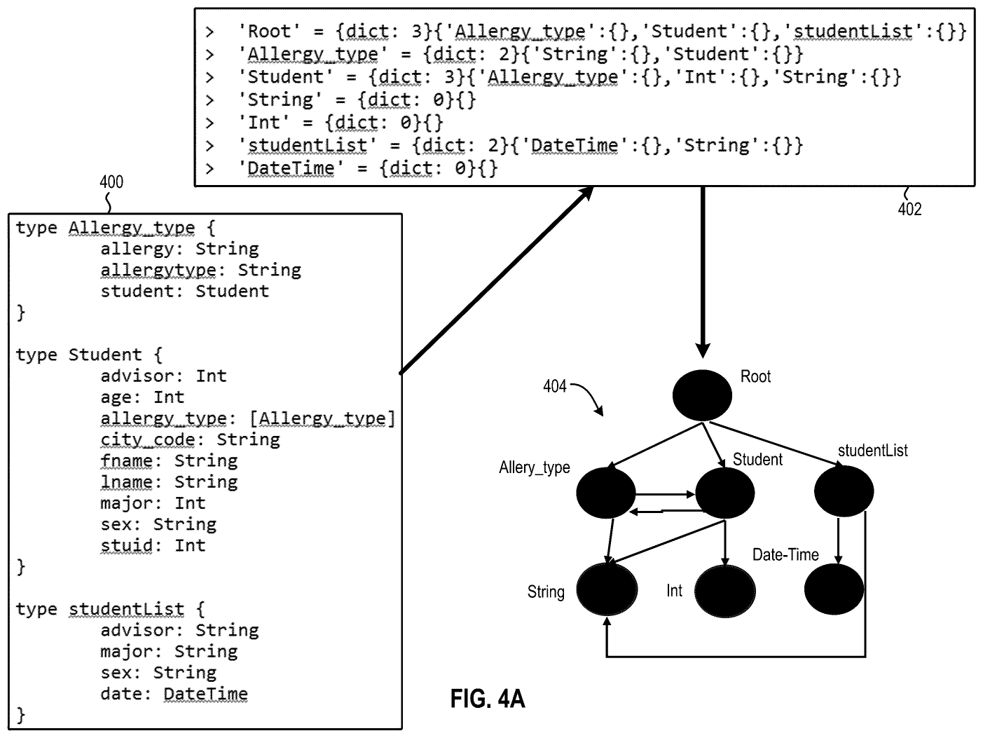

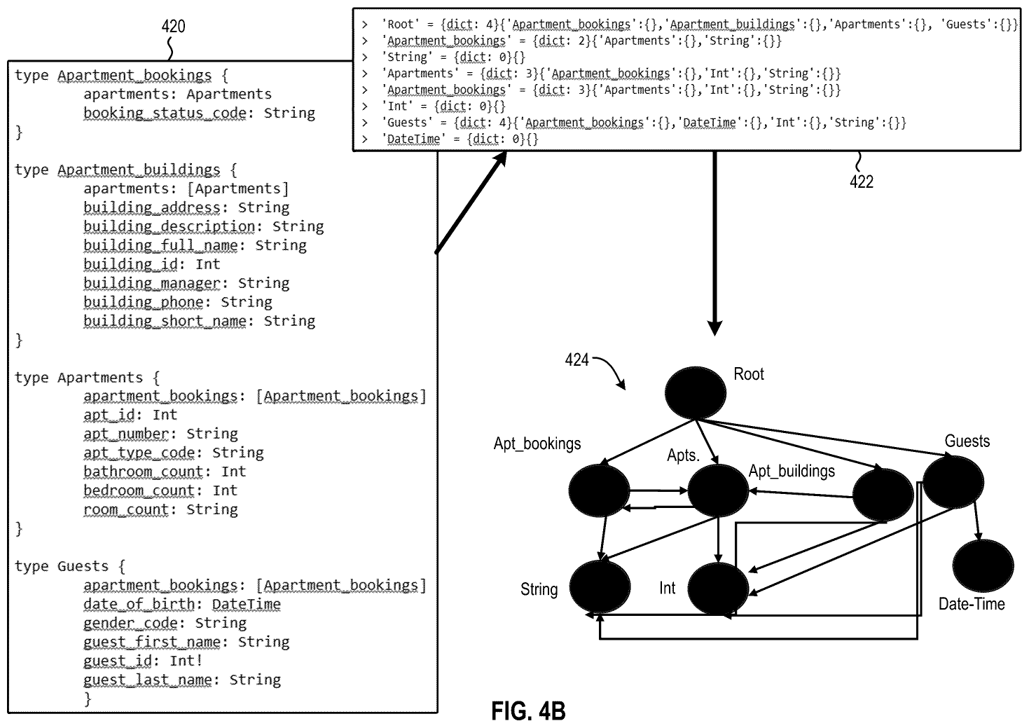

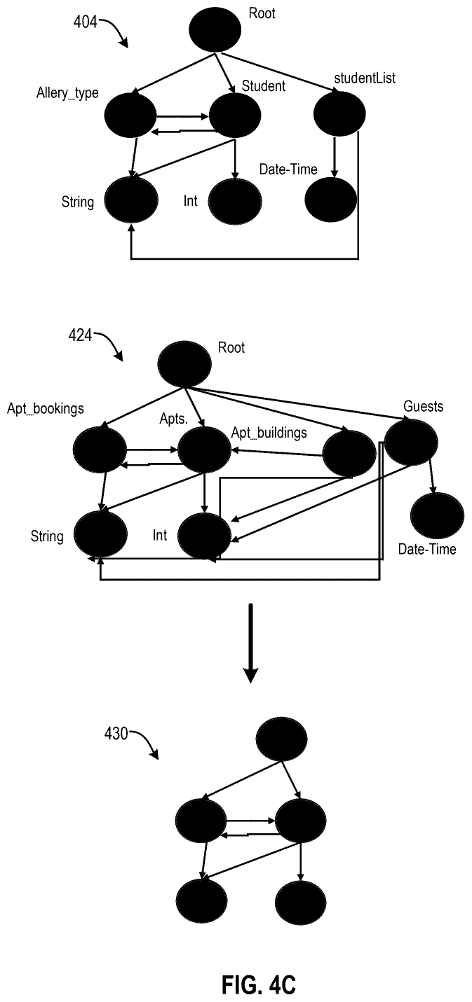

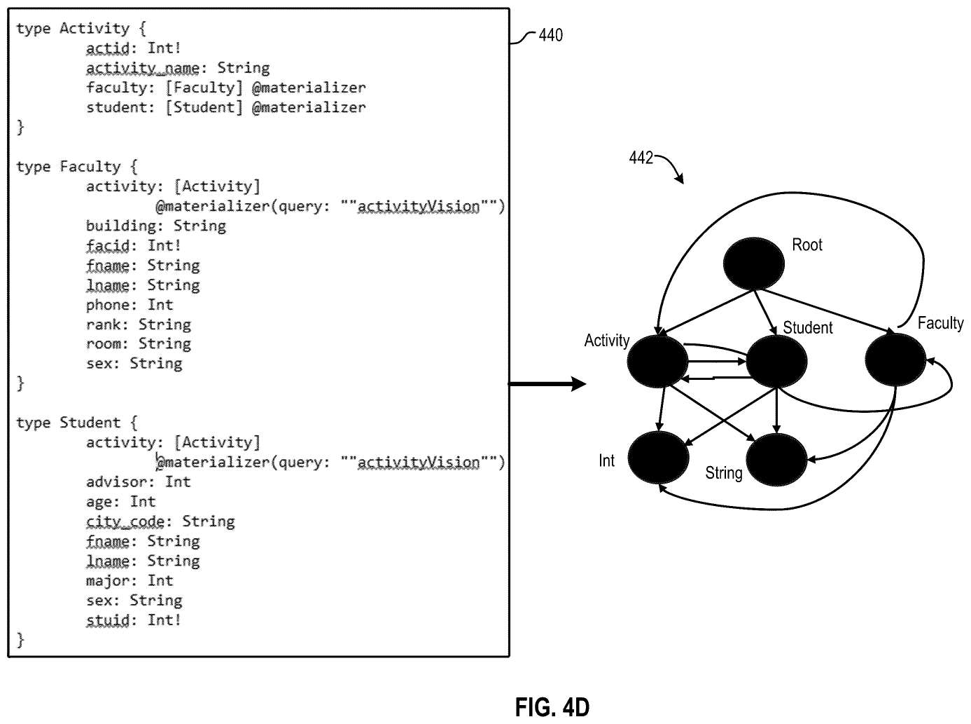

Referring now to FIGS. 4A-4D, illustrations of how schema structure information, schema category information and/or natural language (e.g., semantic) information may be evaluated and used to identify similar entries in a pool are illustrated in accordance with in-use examples. It follows that any of the approaches described with respect to FIGS. 4A-4D may be implemented in any of the approaches herein (e.g., see method 300 of FIG. 3).

Looking first to FIG. 4A, a query schema 400 (e.g., test sample) may be received from a user and is evaluated. For instance, schema structure information may be extracted from the received schema 400. Moreover, the schema structure information (and any other extracted schema information) may be used to convert the received schema 400 into a code based representation 402. The code based representation 402 is also translated into a graphical representation 404. As shown, the graphical representation 404 depicts the overall schema structure as well as the schema categories. For instance, the general shape of the graphical representation 404 and the nodes included therein represents at least a portion of the schema structure associated with the received schema 400. Moreover, the labeled and arrowed lines extending between the nodes represents the schema categories that were extracted from the schema 400.

As noted above, structure level similarity between a query sample schema and one or more entries in a repository pool may be determined. This will help identify samples that are similar at schema structure level. Moreover, it involves converting schema information into a graphical representation as outlined above. Moreover, the graphical representation is used to identify maximum size query schema subgraph which is isomorphic to one or more other subgraphs. Further still, similarity metrics may be implemented on top of this.

Accordingly, FIG. 4B illustrates an illustrative entry from a pool that may be compared against the schema 400 of FIG. 4A. As shown, the schema structure information (and any other extracted schema information) may be used to convert the pool entry 420 into a code based representation 422. The code based representation 422 is also translated into a graphical representation 424. As shown, the graphical representation 424 depicts the overall schema structure as well as the schema categories. For instance, the general shape of the graphical representation 424 and the nodes included therein represents at least a portion of the schema structure associated with the pool entry 420. Moreover, the labeled and arrowed lines extending between the nodes represents the schema categories that were extracted from the entry 420.

Proceeding now to FIG. 4C, the two graphical representations 404 and 424 are compared to determine the largest common sub-isomorphic graph. In other words, the graphical representation 424 of the pool entry is compared against the graphical representation 404 of the original schema to identify any common nodes and/or connections therebetween. This desirably incorporates the schema structure and schema categories while determining how similar the two are. Accordingly, a final graphical representation 430 that illustrates the similarities in structure and/or categories is formed.

In some approaches, the final graphical representation 430 effectively serves as a similarity score for the initial schema 400 and the potential pool entry 420. For instance, the similarity between two graphical representations (e.g., 404 and 424) is determined by counting the number of edges in a first isomorphic graph, and dividing it by the number of edges in a query graph. According to the present in-use example, which again is in no way intended to be limiting, graphical representation 404 includes seven edges therein, while graphical representation 424 includes ten edges. Accordingly, the similarity score for the final graphical representation 430 may be calculated by dividing 7/10, which results in a similarity score of 0.7, or alternatively 70%.

Similar evaluations may be made with respect to schema category information. For instance, approaches may predict possible scenarios from a test sample (also referred to herein as “schema”), e.g., such as filter types, multi-hop types, etc., and select entries from the pool which falls under the same or similar category. This will help to ensure that even a small number of samples are able to capture the similar schema level complexity, e.g., as would be appreciated by one skilled in the art after reading the present description. FIG. 4D depicts an illustrative list 440 of category objects that were extracted from a given query schema.

The schema category based information included in the illustrative list 440 of category objects may thereby be converted into a graphical representation 442 that illustrates the relationship between the various categories therein. For instance, the arrowed line extending from Activity to Student represents a Hop 1 transition. Similarly, the arrowed line extending from Student back to Activity represents another Hop 1 transition. The arrowed line extending from Activity to Faculty represents yet another Hop 1 transition. Furthermore, the arrowed line extending from Faculty to Activity, and then from Activity to Student represents a Hop 2 transition. Thus, the graphical representation 442 may be simplified and represented as Hops: [1, 2], indicating there are Hop 1 and Hop 2 transitions therein. Moreover, any filters in the illustrative list 440 may also be identified and represented. For example, an implementation having float type, string type, and Integer type filters may be represented as Filters=[Float, String, Int.], e.g., as would be appreciated by one skilled in the art after reading the present description. Approaches herein are thereby able to predict possible scenarios from a test schema (e.g., like implicit filters type, explicit filter type, multi-hop types, alias, etc.), and then select one or more examples entries from the pool (e.g., a “few shot pool”) which falls under the same or similar categories, e.g., as would be appreciated by one skilled in the art after reading the present description.

Accordingly, by comparing the number and/or type of hops that are in a pool entry in comparison to a test sample, a level of similarity between the two may be determined. For example, a pool entry and test sample determined as each having two Hop 1 transitions may be determined as having a similarity score of 2/2, or 1. However, a pool entry with one Hop 2 transition and a test sample determined as having two Hop 2 transitions may be determined as having a similarity score of 1/2, or 0.5. Similarly, the number and/or type of filters extracted from a pool entry may be compared against those extracted from a test sample. For instance, a pool entry and test sample determined as each having no filters may have a similarity score of 0/0, or 0.

The process of extracting filters from a given query schema according to some approaches includes simplifying the schema, and extracting input objects therefrom. The input objects extracted from the query schema undergo expansion, which allows for the unique filters to be extracted therefrom, e.g., as would be appreciated by one skilled in the art after reading the present description.

Similarly, natural language information extracted from pool entries may be compared against natural language information extracted from a test sample. Moreover, the pool samples that have a highest similarity score to the semantics used in the test sample may be identified as the closest match and used to perform in-context learning as described in the approaches herein.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A method, comprising:
receiving a test sample having schema information and natural language information;
comparing the schema information to a pool of entries that correspond to a given query language;
identifying one or more entries in the pool that match the schema information of the test sample;
identifying one or more entries in the pool that match the natural language information of the test sample;
causing selected ones of the entries that match the schema information and selected ones of the entries that match the natural language information to be merged; and
causing a large language model (LLM) to perform in-context learning using the merged entries and the test sample.

2. The method of claim 1, wherein the given query language is GraphQL.

3. The method of claim 2, further comprising:
receiving a GraphQL query generated by the LLM; and
using the GraphQL query to solve the test sample.

4. The method of claim 1, wherein the comparing the schema information to the pool of entries comprises:
comparing a structure of the schema information to structures of the pool of entries; and
comparing a category of the schema information to categories of the pool of entries.

5. The method of claim 1, wherein entries in the pool include: schema information, natural language information, and corresponding query information.

6. The method of claim 1, wherein the causing the entries that match the schema information of the test sample and the entries that match the natural language information of the test sample to be ranked comprises:
sending one or more instructions to a ranking mechanism.

7. The method of claim 1, wherein the identifying one or more entries in the pool that match the schema information of the test sample comprises:
calculating a similarity score between the schema information of the test sample and the schema information of the respective entries in the pool,
wherein identifying one or more entries in the pool that match the natural language information of the test sample comprises:
calculating a similarity score between the natural language information of the test sample and the natural language information of the respective entries in the pool.

8. The method of claim 7, further comprising:
causing the entries that match the schema information and the entries that match the natural language information to be ranked by a ranking mechanism; and
causing selected ones of the ranked entries that match the schema information and selected ones of the ranked entries that match the natural language information to be merged.

9. The method of claim 8, wherein the ranking mechanism is configured to rank the entries that match the schema information and/or the entries that match the natural language information based at least in part on a weighted combination of the similarity scores.

10. The method of claim 1, wherein the LLM performs the in-context learning at an end application, wherein the pool of entries is stored at a cloud location.

11. A computer program product, comprising:
one or more computer-readable storage media; and
program instructions stored on the one or more storage media to perform operations comprising:
receiving a test sample having schema information and natural language information;
comparing the schema information to a pool of entries that correspond to a given query language;
identifying one or more entries in the pool that match the schema information of the test sample;
identifying one or more entries in the pool that match the natural language information of the test sample;
causing selected ones of the entries that match the schema information and selected ones of the entries that match the natural language information to be merged; and
causing a large language model (LLM) to perform in-context learning using the merged entries and the test sample.

12. The computer program product of claim 11, wherein the given query language is GraphQL.

13. The computer program product of claim 12, wherein the operations further comprise:
receiving a GraphQL query generated by the LLM; and
using the GraphQL query to solve the test sample.

14. The computer program product of claim 11, wherein the comparing the schema information to the pool of entries comprises:
comparing a structure of the schema information to structures of the pool of entries; and
comparing a category of the schema information to categories of the pool of entries.

15. The computer program product of claim 11, wherein entries in the pool include:
schema information, natural language information, and corresponding query information.

16. The computer program product of claim 11, wherein the causing the entries that match the schema information of the test sample and the entries that match the natural language information of the test sample to be ranked comprises:
sending one or more instructions to a ranking mechanism.

17. The computer program product of claim 11, wherein the identifying one or more entries in the pool that match the schema information of the test sample comprises:
calculating a similarity score between the schema information of the test sample and the schema information of the respective entries in the pool,
wherein identifying one or more entries in the pool that match the natural language information of the test sample comprises:
calculating a similarity score between the natural language information of the test sample and the natural language information of the respective entries in the pool.

18. The computer program product of claim 17, wherein the operations further comprise:
causing the entries that match the schema information and the entries that match the natural language information to be ranked by a ranking mechanism; and
causing selected ones of the ranked entries that match the schema information and selected ones of the ranked entries that match the natural language information to be merged,
wherein the ranking mechanism is configured to rank the entries that match the schema information and/or the entries that match the natural language information based at least in part on a weighted combination of the similarity scores.

19. The computer program product of claim 11, wherein the LLM performs the in-context learning at an end application, wherein the pool of entries is stored at a cloud location.

20. A computer system comprising:
a processor set;
one or more computer-readable storage media; and
program instructions stored on the one or more storage media to cause the processor set to perform operations comprising:
receiving a test sample having schema information and natural language information;
comparing the schema information to a pool of entries that correspond to a given query language;
identifying one or more entries in the pool that match the schema information of the test sample;
identifying one or more entries in the pool that match the natural language information of the test sample;
causing selected ones of the entries that match the schema information and selected ones of the entries that match the natural language information to be merged; and
causing a large language model (LLM) to perform in-context learning using the merged entries and the test sample.
